(19) United States
(12) Patent Application Publication
(10) Pub. No.: US 2025/0307646 A1
(43) Pub. Date: Oct. 2, 2025

(54) NEURAL NETWORKS FOR COLLISION DETECTION

(71) Applicant: Allstate Insurance Company, Northbrook, IL (US)

(72) Inventor: Lucas Antony, Chicago, IL (US)

(21) Appl. No.: 18/617,074

(22) Filed: Mar. 26, 2024

(51) Int. Cl. G06N 3/096; G06N 3/0464

(52) U.S. Cl. CPC G06N 3/096; G06N 3/0464

(57) ABSTRACT

A method may include inputting, in a machine-learning collision prediction model, a set of one or more kinematic variables associated with a trigger event, which may be based on movement of a mobile device and may be recorded over a duration of time. The machine-learning collision prediction model may include a convolutional neural network (CNN) model layer, a long short-term memory (LSTM) model layer, and a prediction model layer. The CNN model may extract features for time segments of the duration of time, and the respective features associated with respective time segments are fed into the LSTM model layer. The machine-learning collision prediction model may generate a prediction score based on the set of one or more kinematic variables and associated with the event. The prediction score may determine a prediction that the event is a type of impact and outputting the prediction. The outputted prediction may be time-oriented.

### TECHNICAL FIELD

Aspects of the presently disclosed technology relate generally to predicting collisions and more particularly to collision prediction using high-efficiency neural network modeling.

### BACKGROUND

Collision detection involves determining whether there has been an intersection of two or more objects. There are different ways of determining a set of trigger parameters that would be used for predicting whether or not a vehicular collision has occurred. However, even sophisticated collision detection systems may result in false positives, since there are different types of movement that are similar to collisions when measuring impact. However, such movements may not necessarily be a vehicular collision. With these observations in mind, among others, various aspects of the present disclosure were conceived and developed.

### BRIEF SUMMARY

In some aspects, the techniques described herein relate to a method of collision prediction using machine-learning, which may include inputting, in a machine-learning collision prediction model, a set of one or more kinematic variables associated with a trigger event. The set of one or more kinematic variables may be based on movement of a mobile device and may be recorded over a duration of time. The machine-learning collision prediction model may include at least a convolutional neural network (CNN) model layer, a long short-term memory (LSTM) model layer, and a prediction model layer. The CNN model may extract features for time segments of the duration of time, and the respective features associated with respective time segments are fed into the LSTM model layer. The machine-learning collision prediction model may generate a prediction score. The prediction score may be based on the set of one or more kinematic variables and associated with the event. The method may further include determining a prediction, according to the prediction score, that the event is a type of impact, and outputting the prediction. The outputted prediction may be time-oriented.

In another aspect, the method may further include generating the machine-learning collision prediction model by training a first collision prediction algorithm. The training may include training data including a training dataset comprising a first set of events associated with a first type of data, and a second set of events associated with a second type of data. The first type of data and the second type of data may be indicative of a same type of impact.

In another aspect, the method may further include generating a high frequency CNN model and a low frequency CNN model in the CNN model layer. The high frequency CNN model and the low frequency CNN model may feed into respective LSTM models in the LSTM model layer. The method may further include concatenating outputs of the respective LSTM models together and inputting the concatenated outputs into a dense layer to alter one or more dimensions of the concatenated outputs. The method may further include inputting the altered outputs into a prediction layer to output the prediction. In another aspect, the prediction layer may output the prediction using transfer learning. In another aspect, the high frequency CNN model receives accelerometer magnitude and interpolated global positioning system (GPS) speeds to a matching frequency that is convoluted together. The low frequency CNN model may receive at least one of GPS speed, horizontal accuracy, and altitude. In another aspect, the set of kinematic variables include at least one of global positioning system (GPS) speed variables, GPS altitude variables, and accelerometer magnitude variables. In another aspect, the prediction may be generated based on a value of the prediction score being at or above a threshold value.

In another aspect, the type of impact may be a first type of impact or a second type of impact, and wherein the first type of impact and the second type of impact are associated with an event type. In another aspect, wherein the event type associated with the first type of impact is a collision and the event type associated with the second type of impact is no collision. In another aspect, the method further includes determining, according to the set of one or more kinematic variables, that the event occurred within a geographic region indicated by one or more geospatial filters. The method may further include generating the prediction that the event is the second type of impact based on the determination that the event occurred within the geographic region. In another aspect, the method further includes converting the set of one or more kinematic variables into features that represent GPS speed and altitude properties and accelerometer magnitude properties associated with the movement of the mobile device. The prediction score may be determined based on the features and the machine-learning collision prediction model may be trained to learn which of the features contribute to predicting whether the movement is associated with the first type of impact.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed descriptions are to be regarded as illustrative in nature and not limiting.

### BRIEF DESCRIPTION OF THE DRAWINGS

FIG. 1 illustrates an example diagram showing a prediction system for generating a prediction for a likelihood of a collision based on a collision prediction model according to some aspects of the present disclosure.

FIG. 2 illustrates an example network environment with one or more computing devices for generating a prediction for a likelihood of a collision based on a collision prediction model according to some aspects of the present disclosure.

FIG. 3 illustrates an example neural network architecture according to some aspects of the present disclosure.

FIG. 4 illustrates example operations for generating a prediction for a likelihood of a collision based on a collision prediction model according to some aspects of the present disclosure.

FIG. 5 illustrates example operations for training the prediction model for generating a prediction for a likelihood of a collision based on training data for generating a prediction for a likelihood of a collision based on a respective collision according to some aspects of the present disclosure.

### DETAILED DESCRIPTION

When implementing collision-prediction algorithms and technologies, efficiency, expediency, and accuracy are of over-arching importance in order to accurately and quickly determine if a vehicle has been involved in a potentially harmful collision. Implementing neural networks, machine-learning, and artificial intelligence streamlines processing power significantly, allowing for fast processing and response times. The technology disclosed herein incorporates at least two species of neural networks trained to predict whether a collision has occurred during a particular event detected by sensors of a mobile device and/or a vehicle.

Inputs for a neural network may include one or more elements of data from one or more sensors associated with a user. The elements of data may include accelerometer data (e.g., accelerometer magnitude for a time step over a duration of time in a direction), global positioning system (GPS) data (e.g., speed data, geographical location data, etc.), gyroscope data, barometer data, pressure sensor data, any combination thereof, or the like. The sensors may be associated with a mobile device associated with the user. In some examples, the sensors may exist on another device, including, but not limited to, the vehicle itself, a laptop, a tablet, a smartwatch, or any other device capable of housing one or more sensors. The one or more sensors may output data at different frequencies (e.g., 1 Hz, 25 Hz, etc.). For example, GPS data may be received at 1 Hz and accelerometer data may be received at 25 Hz. The data received may be convoluted together, interpolated, and/or converted to obtain data of the same frequency for processing.

In some examples, the data from the one or more sensors may be input into two different models of the neural network. For example, there may be a 1 Hz model and a 25 Hz model, wherein the 1 Hz model includes GPS data and interpolated and/or extrapolated accelerometer data. In the same example, the 25 Hz model may include accelerometer data and interpolated and/or extrapolated GPS data. The two models may indicate two data points associated with each sensor of the one or more sensors for an indicated time point (e.g., a 1 Hz reading and a 25 Hz reading, wherein one of the readings may be interpolated and/or extrapolated from the data received from the sensor).

At or near the occurrence of a trigger event (determined based on a trigger threshold, for example), the neural network may process this data using one or more machine-learning models trained to predict the outcome of an event according to a collision prediction model. For example, the neural network may comprise a convolutional neural network (CNN) and a long short-term memory network (LSTM) trained to output a prediction. In order to complete the prediction, the neural network may receive input data collected over a duration of time in order to achieve increased accuracy. For example, the neural network may receive input data collected over a 20 second duration. The 20 second duration may occur prior to the event, during the event, after the event, or any combination thereof. In some examples, the duration of time may differ for different models within the neural network. For example, lower frequency data (e.g., a 1 Hz model of a model) may have a longer duration of time than higher frequency data (e.g., a 25 Hz model of a model), such as 40 seconds and 30 seconds, respectively. In collision prediction, a shorter duration of time typically indicates a faster response time for the associated neural network, therefore decreasing processing time and power. A faster processing time thereby permits faster reactions by emergency personnel, first responders, emergency contacts, etc.

The input data may be processed by the CNN using one or more hidden layers. The CNN may include one or more models. The one or more models may include data received at one or more different frequencies (e.g., 1 Hz model and 25 Hz model). The data may be additionally processed by a pooling layer, which may alter the dimensionality of the data accordingly for input into the LSTM. The LSTM may perform additional processing and output a value indicating a prediction for whether the event was a first type of impact or a second type of impact. For example, the LSTM may concatenate the models from one or more models output from the CNN, process the one or more models through a dense layer, then process the output of the dense layer through a prediction layer to output the value. The value may be any number between 0 and 1, where a value closer to 0 indicates a higher likelihood of the event being the second type of impact, and where a value closer to 1 indicates a higher likelihood of the event being the first type of impact. In some examples, the LSTM may output a binary output of 0 or 1, true or false, collision or no collision, etc. The CNN and the LSTM may be trained using historical event data, including data associated with the first type of impact and/or data associated with the second type of impact.

In some examples, a threshold value may be associated with the first type of impact. For example, if the threshold value is 0.8, and the value is 0.68, then the respective event associated with the value would be predicted as the second type of impact. Contrarily, if the value is 0.89, then the respective event associated with the value would be predicted as the first type of impact. In some examples, the neural network may determine an appropriate threshold value associated with the first type of impact. In some other examples, an administrator may determine the appropriate threshold value and manually input the appropriate threshold value. The first type of impact may be a collision of a vehicle, motorcycle, electric scooter, boat, bicycle, any combination thereof, or the like. The second type of impact may be any event that is not a collision, such as a roller coaster, skiing, water sports, action sports, etc.

In some examples, the prediction generated by the neural network may be output to one or more entities, devices, and/or networks, depending on the prediction. For example, if the event is predicted as the first type of impact, first responders may be notified. In some other examples, if the event is predicted as the second type of impact, a user interface associated with the mobile device may present a visual prompt to the user requesting feedback, including questions regarding the event.

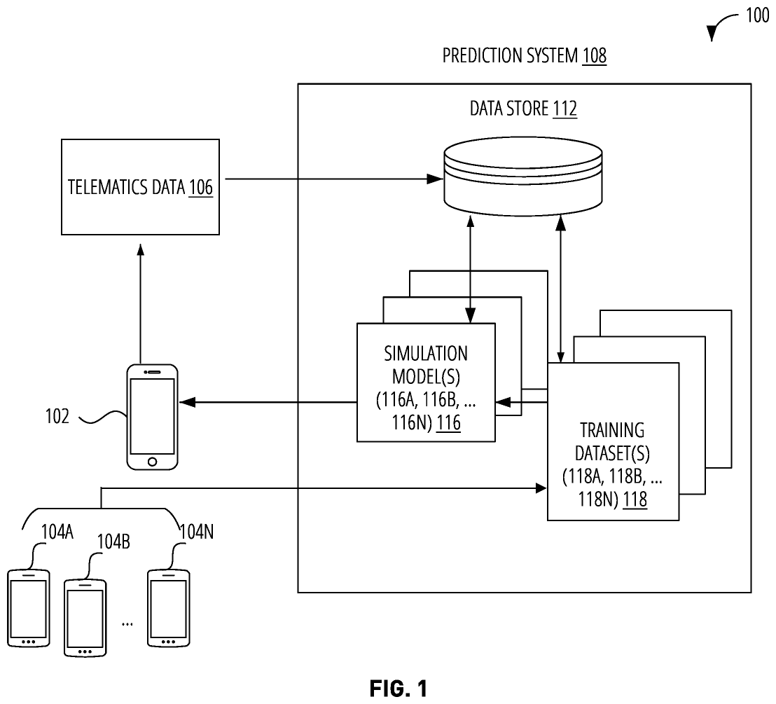

To begin a detailed description of an example diagram 100 showing a prediction system for generating a prediction for a likelihood of a collision based on a respective collision prediction algorithm for a particular type of impact is made to FIG. 1. Device 102, such as a mobile device or some other form of telematics device, may collect telematics data 106. Telematics data 106 may be collected from a global position system (GPS), micro-electro-mechanical system (MEMS) sensors, and other data logging tools. Telematics data 106 captured can include location, speed, idling time, harsh acceleration or braking, vehicle faults, and more.

Telematics data 106 may be sent to a prediction system 108 to ultimately output a prediction that the movement occurring during an event is not associated with the first type of impact when the first prediction score is below a threshold score. Prediction system 108 may comprise a remote processor, partially comprise the remote processor and use one or more processors on device 102, or fully determine the prediction on one or more processors on device 102. If prediction system 108 is remote, data sent to and from a mobile application may be via an application programming interface (API).

Telematics data 106, which may include at least one of global positioning system (GPS) speed variables, GPS altitude variables, and accelerometer magnitude variables, may be stored at data store 112 or at the device 102. In some cases, the kinematic variables may be associated with a convolutional neural network (CNN) model and the collision prediction model is a combination of a collision prediction CNN and a collision prediction long short-term memory model (LSTM). Simulation models 116 (of a plurality of different simulation models 116A, 116B, . . . 116N) may receive telematics data 106 from data store 112 or may directly receive telematics data 106. A first simulation model of simulation models 116 (e.g., 116A) may extract a first subset of the kinematic variables based on a first time window associated with a first type of impact. The simulation models 116 may receive, by a collision prediction model, the first subset of variables. The first simulation model may determine, by the collision prediction model, a first prediction score based on the first subset of variables, the first prediction score associated with a likelihood that the movement is associated with the first type of impact.

The first type of impact may be associated with the collision prediction model. Consequently, the first simulation model may output a prediction that the movement is not association with the first type of impact when the first prediction score is below a threshold score. As such, the prediction model 116A may be trained by a respective training datasets 118 (of a plurality of different respective training datasets 118A, 118B, . . . 118N). The prediction model may be trained by a collision prediction model and may receive a dataset from counterfactual collisions from the data store 112. The dataset may be collected data from other devices 104A, 104B, . . . 104N. The counterfactual collisions may include movement that was not associated with a first type of impact (e.g., associated with a second type of impact) and actual historical instances associated with the first type of impact.

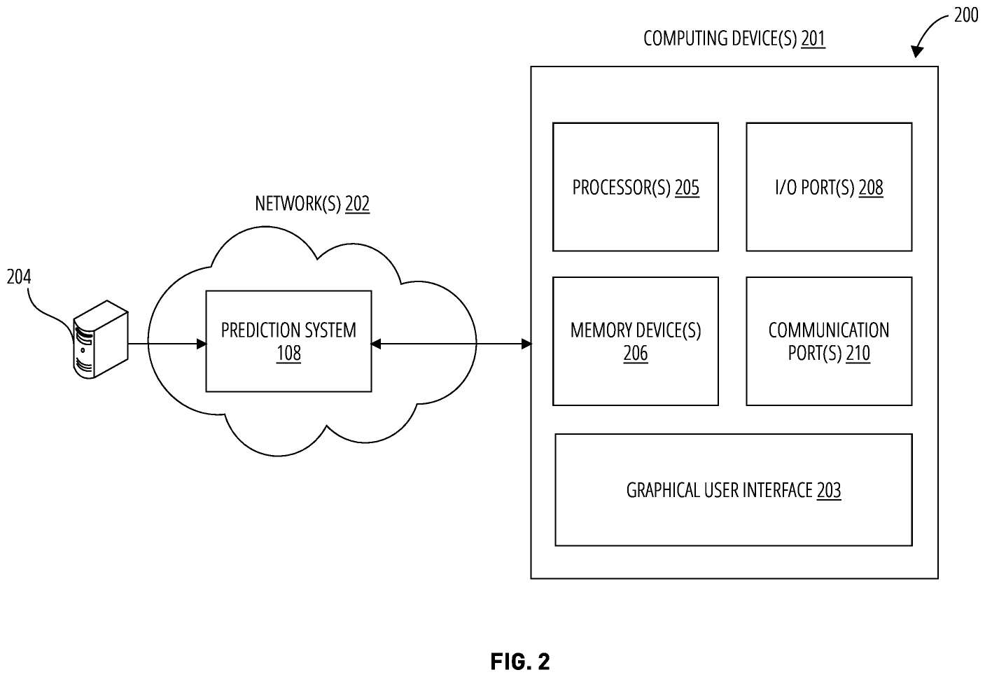

FIG. 2 illustrates an example network environment with one or more computing devices for generating a prediction for a likelihood of a collision based on a respective collision prediction algorithm for a particular type of impact. The example network environment 200 includes one or more network(s) 202, which can be a cellular network such as a 3rd Generation Partnership Project (3GPP) network, a third generation (3G) network, a fourth generation (4G) network, a fifth generation (5G) network, a Long-Term Evolution (LTE), an LTE Advanced Network, a Global System for Mobile Communications (GSM) network, a Universal Mobile Telecommunications System (UMTS) network, and the like. Moreover, network(s) 202 can include any type of network, such as the Internet, an intranet, a Virtual Private Network (VPN), a Voice over Internet Protocol (VOIP) network, a wireless network (e.g., Bluetooth), a cellular network, a satellite network, combinations thereof, etc.

In some cases, device 102 (as described in FIG. 1) runs software and/or a software development kit (SDK) that generate a prediction for a likelihood of a collision based on the collision prediction model. In some cases, the models and associated logic may be accessed remotely via the cloud and applied on device 102. A local model may reside on the device 102 in the case the device 102 is offline.

Network(s) 202 provide access to and interactions with systems to generate a prediction for a likelihood of a collision based on the collision prediction model. Network(s) 202 can include communications network components such as, but not limited to gateways routers, servers, and registrars, which enable communication across network(s) 202. In one implementation, the communications network components include multiple ingress/egress routers, which may have one or more ports, in communication with network(s) 202. Communication via any of the networks can be wired, wireless, or any combination thereof.

The network environment 200 may also include at least one server device 204 hosting software, application(s), websites, and the like for operating prediction system 108 for generating a prediction for a likelihood of a collision based on the collision prediction model. Prediction system 108 can receive inputs from various computing devices and transform the received input data into other unique types of data. Server device 204 may be a single server, a plurality of servers with each such server being a physical server or a virtual machine, or a collection of both physical servers and virtual machines.

In another implementation, a cloud hosts one or more components of systems 100-200. Server device 204 may represent an instance among large instances of application servers in a cloud computing environment, a data center, or other computing environment. The server device 204 can access data stored at one or more database(s) (e.g., including any of the values or identifiers discussed herein). Systems 100-200, the server device 204, and/or other resources connected to network(s) 202 may access one or more other servers to access other websites, applications, web services interfaces, GUIs, storage devices, APIs, computing devices, or the like to perform the techniques discussed herein. The server(s) can include one or more computing device(s) 201, as discussed in greater detail below.

For instance, the network environment 200 can include one or more computing device(s) 201 for executing prediction system 108 and/or generating a prediction for a likelihood of a collision based on the collision prediction model. In one implementation, one or more computing device(s) 201 include one or more server devices 204 executing prediction system 108 as a software application and/or a module or algorithmic component of software.

In some instances, computing device(s) 201 can include a computer, a personal computer, a desktop computer, a laptop computer, a terminal, a workstation, a server device, a cellular or mobile phone, a mobile device, a smart mobile device a tablet, a wearable device (e.g., a smart watch, smart glasses, a smart epidermal device, etc.) a multimedia console, a television, an Internet-of-Things (IoT) device, a smart home device, a medical device, a virtual reality (VR) or augmented reality (AR) device, a vehicle (e.g., a smart bicycle, an automobile computer, etc.), and/or the like. Computing device(s) 201 may be integrated with, form a part of, or otherwise be associated with the systems/network environments 100-200. It will be appreciated that specific implementations of these devices may be of differing possible specific computing architectures not all of which are specifically discussed herein but will be understood by those of ordinary skill in the art.

Computing device(s) 201 may be a computing system capable of executing a computer program product to execute a computer process. Data and program files may be input to computing device(s) 201, which reads the files and executes the programs therein. Some of the elements of the computing device(s) 201 include one or more hardware processor(s) 205, one or more memory device(s) 206, and/or one or more ports, such as input/output (I/O) 208 and communication port(s) 210. Additionally, other elements that will be recognized by those skilled in the art may be included in computing device(s) 201 but are not explicitly depicted in FIG. 1 or discussed further herein. Various elements of computing device(s) 201 may communicate with one another by way of communication port(s) 210 and/or one or more communication buses, point-to-point communication paths, or other communication means.

Processor(s) 205 may include, for example, a central processing unit (CPU), a microprocessor, a microcontroller, a digital signal processor (DSP), and/or one or more internal levels of cache. There may be one or more processor(s) 205, such that processor(s) 205 comprises a single central-processing unit, or a plurality of processing units capable of executing instructions and performing operations in parallel with each other, commonly referred to as a parallel processing environment.

Computing device(s) 201 may be a conventional computer, a distributed computer, or any other type of computer, such as one or more external computers made available via a cloud computing architecture. The presently described technology is optionally implemented in software stored on the data storage device(s) such as the memory device(s) 206, and/or communicated via one or more of the I/O port(s) 208 and the communication port(s) 210, thereby transforming computing device(s) 201 to a special purpose machine for implementing the operations described herein and generating a prediction for a likelihood of a collision based on a collision prediction model. Moreover, computing device(s) 201, as implemented in the systems 100-200, receives various types of input data (e.g., in different data formats) and transforms the input data through the stages of the data flow described herein into new types of data files (e.g., predictions for a likelihood of a collision).

The one or more memory device(s) 206 may include any non-volatile data storage device capable of storing data generated or employed within computing device(s) 201, such as computer executable instructions for performing a computer process, which may include instructions of both application programs and an operating system (OS) that manages the various components of computing device(s) 201. Memory device(s) 206 may include, without limitation, magnetic disk drives, optical disk drives, solid state drives (SSDs), flash drives, and the like. Memory device(s) 206 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory device(s) 206 may include volatile memory (e.g., dynamic random-access memory (DRAM), static random-access memory (SRAM), etc.) and/or non-volatile memory (e.g., read-only memory (ROM), flash memory, etc.).

Computer program products containing mechanisms to effectuate the systems and methods in accordance with the presently described technology may reside in memory device(s) 206 which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, computing device(s) 201 includes one or more ports, such as I/O port(s) 208 and communication port(s) 210, for communicating with other computing or network devices. It will be appreciated that the I/O port(s) 208 and communication port(s) 210 may be combined or separate and that more or fewer ports may be included in computing device(s) 201.

I/O port(s) 208 may be connected to an I/O device, or other device, by which information is input to or output from computing device(s) 201. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into computing device(s) 201 via I/O port(s) 208. Similarly, the output devices may convert electrical signals received from computing device(s) 201 via I/O port(s) 208 into signals that may be sensed as output by a human, such as sound, light, and/or touch. The input device may be an alphanumeric input device, including alphanumeric and other keys for communicating information and/or command selections to processor(s) 205 via I/O port(s) 208. The input device may be another type of user input device including, but not limited to: direction and selection control devices, such as a mouse, a trackball, cursor direction keys, a joystick, and/or a wheel; one or more sensors, such as a camera, a microphone, a positional sensor, an orientation sensor, an inertial sensor, and/or an accelerometer; and/or a touch-sensitive display screen (“touchscreen”). The output devices may include, without limitation, a display, a touchscreen, a speaker, a tactile and/or haptic output device, and/or the like. In some implementations, the input device and the output device may be the same device, for example, in the case of a touchscreen.

In one implementation, communication port(s) 210 is connected to network(s) 202 so computing device(s) 201 can receive network data useful in executing the methods and systems set out herein as well as transmitting information and network configuration changes determined thereby. Stated differently, communication port(s) 210 connects computing device(s) 201 to one or more communication interface devices configured to transmit and/or receive information between computing device(s) 201 and other devices (e.g., network devices of network(s) 202) by way of one or more wired or wireless communication networks or connections. Examples of such networks or connections include, without limitation, Universal Serial Bus (USB), Ethernet, Wi-Fi, Bluetooth®, Near Field Communication (NFC), and so on. One or more such communication interface devices may be utilized via communication port(s) 210 to communicate with one or more other machines, either directly over a point-to-point communication path, over a wide area network (WAN) (e.g., the Internet), over a local area network (LAN), over a cellular network (e.g., third generation (3G), fourth generation (4G), Long-Term Evolution (LTE), fifth generation (5G), etc.) or over another communication means. Further, communication port(s) 210 may communicate with an antenna or other link for electromagnetic signal transmission and/or reception.

In an example, prediction system 108 and/or other software, modules, services, and operations discussed herein may be embodied by instructions stored on memory device(s) 206 and executed by processor(s) 205.

The network environment 200 set forth in FIG. 2 is but one possible example of a computing device or computer system that may be configured in accordance with aspects of the present disclosure. It will be appreciated that other non-transitory tangible computer-readable storage media storing computer-executable instructions for implementing the presently disclosed technology on a computing system may be utilized. In the present disclosure, the methods disclosed may be implemented as sets of instructions or software readable by computing device(s) 201.

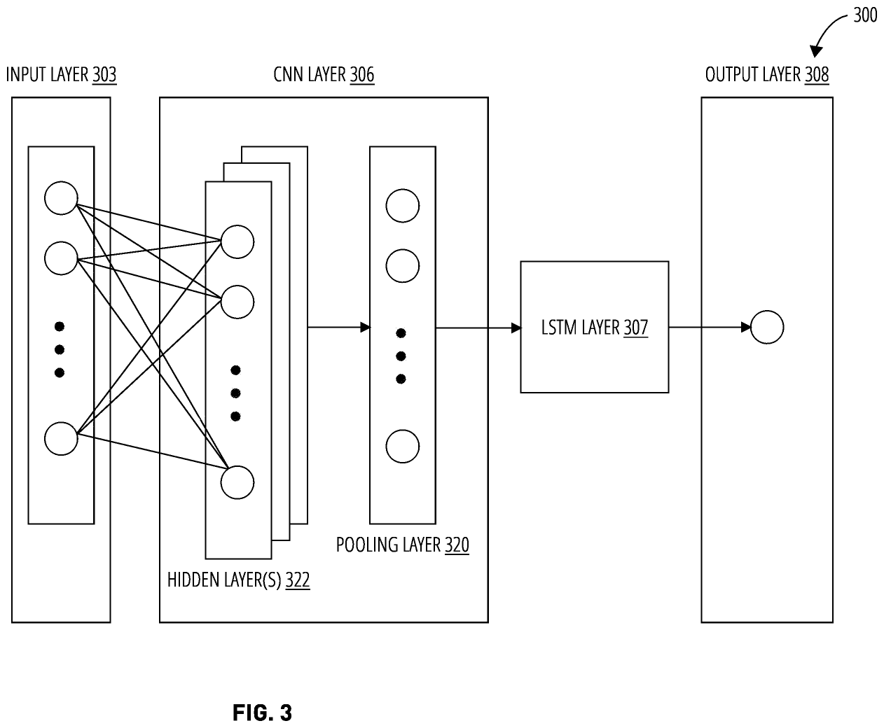

FIG. 3 illustrates an example neural network architecture, in accordance with some aspects of the present technology. Neural network 300 includes a neural network defined by a neural network description in a rendering engine model (neural controller). Neural network 300 may contain one or more different varieties of neural network, including, but not limited to, a collision-detecting convolutional neural network (CNN) and a long short-term memory (LSTM) neural network. Neural network 300 may be associated with determining an output value that may determine a type of impact associated with an event. Neural network 300 can represent a neural network implementation of a rendering engine for rendering media data.

The neural network description can include a full specification of the neural network 300, including input layer 303, CNN layer 306, LSTM layer 307, and output layer 308. For example, the neural network description can include a description or specification of neural network 300 (e.g., the layers, layer interconnections, number of nodes in each layer, etc.); an input and output description which indicates how the input and output are formed or processed; an indication of the activation functions in the neural network, the operations or filters in the neural network, etc.; neural network parameters such as weights, biases, etc.; and so forth.

Neural network 300 is defined in the neural network description. In this example, the neural network 300 includes input layer 303, which includes input data, such as kinematic variables including at least one of global positioning system (GPS) speed variables, GPS altitude variables, and accelerometer magnitude variables. In one illustrative example, the input layer 303 can include data representing a portion of the input media data such as a patch of data or pixels (e.g., a 128×128 patch of data) in an image corresponding to the input media data. Input layer 303 may include data of different frequencies (e.g., 1 Hz and 25 Hz). In some examples, the data included in input layer 303 may be interpolated and/or extrapolated data from kinematic variables.

Neural network 300 can include a convolutional neural network (CNN) included in CNN layer 306. CNN layer 306 may receive the initial input from input layer 303, such as the kinematic variables mentioned herein. In some examples, CNN layer 306 may include one model or may include at least two models required to achieve the desired processing outcome. CNN layer 306 may include hidden layer(s) 322, which may include one or more individual hidden layers. The hidden layer(s) 322 can include n number of hidden layers, where n is an integer greater than or equal to one. The number of hidden layers can include as many layers as needed for a desired processing outcome and/or rendering intent. Neural network 300 further includes LSTM layer 307. LSTM layer 307 may include one or more LSTM algorithms receiving input from CNN layer 306, or as many iterations as needed for a desired processing outcome and/or rendering intent. Neural network 300 further includes an output layer 308 (e.g., a prediction model layer) that provides an output (e.g., paths that are outputted to a trained planning algorithm) resulting from the processing performed by CNN layer 306 and LSTM layer 307. In one illustrative example, the output layer 308 can provide a binary output indicating a type of event and/or impact (e.g., crash, no crash).

CNN layer 306 in this example is a multi-layer neural network of interconnected nodes. Each node can represent a piece of information. Information associated with the nodes is shared among the different layers and each layer retains information as information is processed. In some cases, CNN layer 306 can include a feed-forward neural network, in which case there are no feedback connections where outputs of the neural network are fed back into itself. In other cases, CNN layer 306 can include a recurrent neural network, which can have loops that allow information to be carried across nodes while reading in input.

In some examples, CNN layer 306 may be comprised of one or more models. The models may be distinguished by the type of input. For example, a first model may include 1 Hz input of kinematic variables via input layer 303 and a second model may include 25 Hz input of kinematic variables via input layer 303. The first model and the second model may include data from one time frame. In some examples, the first model and the second model may include data from differing time frames, for example, the first model may include data over a 40 second period and the second model may include data over a 20 second period. The first model and the second model may include the entirety of the data collected regarding a kinematic variable, a portion of the data collected regarding a kinematic variable, interpolated data associated with a kinematic variable, and/or extrapolated data associated with a kinematic variable. For example, the second model may include accelerometer magnitudes and GPS speed data interpolated to 25 Hz.

Information can be exchanged between nodes through node-to-node interconnections between the various layers. Nodes of input layer 303 can activate a set of nodes in hidden layer(s) 322. For example, as shown, each of the input nodes of input layer 303 is connected to each of the nodes of hidden layer(s) 322. The nodes of hidden layer(s) 322 can transform the information of each input node by applying activation functions to the information. The output of the next hidden layer can then activate nodes of the next subsequent hidden layer, and so on. In some cases, while nodes in input layer 303 and CNN layer 306 are shown as having multiple output lines, a node has a single output and all lines shown as being output from a node represent the same output value.

The information derived from the transformation can then be passed to and can activate the nodes of the next hidden layer, which can perform their own designated functions. Example functions include convolutional, up-sampling, data transformation, pooling, and/or any other suitable functions. For example, as shown in FIG. 3, the output of the last hidden layer can activate one or more nodes of pooling layer 320, which may be included in CNN layer 306 to execute pooling functions. CNN layer 306 and/or LSTM layer 307 may be configured to input/output data in a particular format. For instance, LSTM models may be configured to receive a two-dimensional input while CNN models may be configured to output a three-dimensional feature vector. Pooling layer 320 may decrease the dimensionality of the initial output of hidden layer(s) 322 before executing LSTM layer 307. For example, pooling layer 320 may reduce the dimensionality of the three-dimensional feature vector into a two-dimensional input intended for LSTM models. In some examples, pooling layer 320 may be included in hidden layer(s) 322 or may be distinct. In yet additional examples, pooling layer 320 may be unnecessary, redundant, excessive, and/or otherwise moot within neural network 300 and/or CNN layer 306, and may be removed entirely.

The cells of LSTM layer 307 may receive one or more inputs (e.g., the first model and the second model) from CNN layer 306 that may be processed by the LSTM model to generate an output. The LSTM may process the one or more inputs through one or more dense layers. For example, LSTM layer 307 may receive a state input corresponding to the state of the LSTM based on the processes of previously executed cells, a hidden layer input based on the output of the previous cell, and the current input. The first cell of LSTM layer 307 processes the current input and hidden layer input and generates a hidden layer output and determines whether and how to modify the state input. The first cell then outputs the updated state input and the hidden layer output to the next cell. In some examples, the first model and the second model may be concatenated together through one or more layers of LSTM layer 307. After a number of cells (e.g., 2^{nth} cell), the state and hidden layer output from the last cell may be passed through a prediction model layer to generate a prediction output. The prediction model layer may be included in LSTM layer 307. In some examples, the prediction model layer may be included in an additional layer, such as output layer 308. The prediction output may be passed through an algorithm to cause the prediction output to be represented as a value between 0 and 1. In some examples, the output may be a binary output of either 0 or 1, indicating a type of impact (e.g., “1” indicates the first type of impact and “0” indicates the second type of impact). In some examples, an additional processor may determine the type of impact associated with a particular event by evaluating the predictions generated by neural network 300.

In some cases, each node or interconnection between nodes can have a weight that is a set of parameters derived from training neural network 300. For example, an interconnection between nodes can represent a piece of information learned about the interconnected nodes. The interconnection can have a numeric weight that can be tuned (e.g., based on a training dataset), allowing neural network 300 to be adaptive to inputs and able to learn as more data is processed.

Neural network 300 (e.g., CNN layer 306 and/or LSTM layer 307) can be pre-trained to process the features from the data in input layer 303 using the different hidden layer(s) 322 in order to provide the output to LSTM layer 307 and subsequently, output layer 308. In an example in which neural network 300 is used to output a prediction that the movement is not associated with the first type of impact when the prediction score is below a threshold score, neural network 300 can be trained using training data that includes datasets from events where movement was not associated with a first type of impact (e.g., associated with the second type of impact) and actual historical instances associated with the first type of impact. For instance, training images can be input into neural network 300, which can be processed by neural network 300 to generate outputs which can be used to tune one or more aspects of neural network 300, such as weights, biases, etc. In some examples, the data may be used to train an LSTM model. LSTM models are configured to consider time series input (e.g., such as kinematic variables and/or data that correspond to a predetermined time interval associated with an event) when generating an output. In some examples, LSTM layer 307 may be trained to receive data from CNN layer 306 (and/or pooling layer 320) to predict a binary output associated with an event according to data from a duration of time set according to the first type of impact. For example, LSTM layer 307 may process data received over a 20-second time interval.

In some examples, neural network 300 may be trained using transfer learning. Transfer learning is a technique in machine-learning where a machine-learning model initially trained to solve a particular task is used as the starting point for a different task. Transfer learning can be useful when the second task is somewhat similar to the first take, or when there is training data available for the second task. For example, a neural network initially trained to predict a type of impact associated with an event may be further trained to predict whether an event is a collision.

In some cases, neural network 300 can adjust weights of nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training media data until the weights of the layers are accurately tuned.

For a first training iteration for neural network 300, the output can include values that do not give preference to any particular class due to the weights being randomly selected at initialization. For example, if the output is a vector with probabilities that the object includes different product(s) and/or different users, the probability value for each of the different product and/or user may be equal or at least very similar (e.g., for ten possible products or users, each class may have a probability value of 0.1). With the initial weights, neural network 300 is unable to determine low level features and thus cannot make an accurate determination of what the classification of the object might be. A loss function can be used to analyze errors in the output. Any suitable loss function definition can be used.

The loss (or error) can be high for the first training dataset (e.g., images) since the actual values will be different than the predicted output. The goal of training is to minimize the amount of loss so that the predicted output comports with a target or ideal output. Neural network 300 can perform a backward pass by determining which inputs (weights) most contributed to the loss of neural network 300, and can adjust the weights so that the loss decreases and is eventually minimized.

A derivative of the loss with respect to the weights can be computed to determine the weights that contributed most to the loss of neural network 300. After the derivative is computed, a weight update can be performed by updating the weights of the filters. For example, the weights can be updated so that they change in the opposite direction of the gradient. A learning rate can be set to any suitable value, with a high learning rate including larger weight updates and a lower value indicating smaller weight updates.

Neural network 300 can include any suitable neural or deep learning network. As shown in FIG. 3, one example includes a convolutional neural network (CNN) and a long short-term memory (LSTM) neural network, which also includes an input layer and an output layer, with multiple hidden layers between the input and out layers. The hidden layers of a CNN include a series of convolutional, nonlinear, pooling (for downsampling), and fully connected layers. In other examples, neural network 300 can represent any other neural or deep learning network, such as an autoencoder, a deep belief nets (DBNs), a recurrent neural network (RNN), etc.

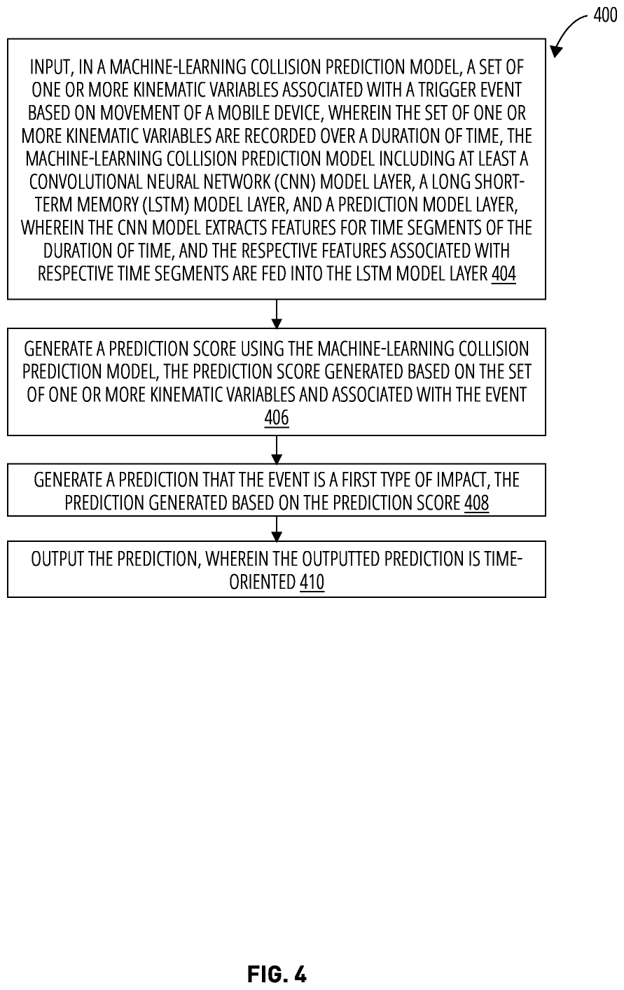

FIG. 4 illustrates example operations for generating a prediction for a likelihood of a collision based on a collision prediction model, which can be performed by any of the systems 100-200 and/or network environment 200. At operation 404, the method 400 includes inputting, in a machine-learning collision prediction model, a set of one or more kinematic variables associated with a trigger event based on movement of a mobile device, wherein the set of one or more kinematic variables are recorded over a duration of time, the machine-learning collision prediction model including at least a convolutional neural network (CNN) model layer, a long short-term memory (LSTM) model layer, and a prediction model layer, wherein the CNN model extracts features for time segments of the duration of time, and the respective features associated with respective time segments are fed into the LSTM model layer. The set of kinematic variables may be received from one or more sensors associated with the mobile device, including, but not limited to, a global positioning system, an accelerometer, a barometer, etc. The set of kinematic variables may be associated with data collected over the duration of time, such as a speed, a geographic location, an altitude, an acceleration, etc. The duration of time may be any duration of time indicated by a number of nanoseconds, milliseconds, seconds, minutes, etc. For example, the duration of time may be 20 seconds, 60 seconds, or 90 seconds.

At operation 406, the method 400 includes generating a prediction score using the machine-learning collision prediction model, the prediction score generated based on the set of one or more kinematic variables and associated with the event. The collision prediction model may be comprised of at least a convolutional neural network (CNN) and a long short-term memory system (LSTM). The CNN and LSTM may operate to generate the prediction score, which may be a single number output ranging from 0 to 1, where a prediction score closer to 0 indicates a likelihood of the second type of impact and a prediction score closer to 1 indicates a likelihood of the first type of impact. In some examples, the prediction score may be a binary output (e.g., 0 or 1, true or false, yes or no, collision or no collision, etc.).

At operation 408, the method 400 includes generating a prediction that the event is a type of impact, the prediction generated based on the prediction score. The prediction may be a type of impact, such as a first type of impact or a second type of impact. The first type of impact and the second type of impact may be associated with an event type, which may indicate whether a collision has occurred. For example, the prediction may indicate that the type of impact is the second type of impact, which indicates that an event type of no collision has occurred (e.g., the event was likely due to skiing, a roller coaster, water sports, etc.). In some examples, the first type of impact is associated with an event type of collision. At operation 410, the method 400 includes outputting the prediction, wherein the outputted prediction is time-oriented. An indication of the prediction may be output on a user interface of the mobile device. Additionally, a notification associated with the prediction may be output to one or more additional devices, including devices associated with an insurance carrier, a first responder, an emergency contact, any combination thereof, or the like. The notification may include data pertaining to the event, request an action from the one or more devices, and/or may include a prompt for a user of the one or more devices. For example, a notification may be transmitted to a first responder indicating a vehicle collision has occurred, data that may be indicative of the severity of the collision (e.g., altitude, speed at impact, make/model of vehicle involved, etc.), identities of one or more individuals involved in the collision (e.g., identity of a user associated with the mobile device), and a request to dispatch an ambulance. As another example, a notification may be transmitted to an emergency contact associated with the user associated with the mobile device that may include the location of the collision and an opportunity to contact the mobile device.

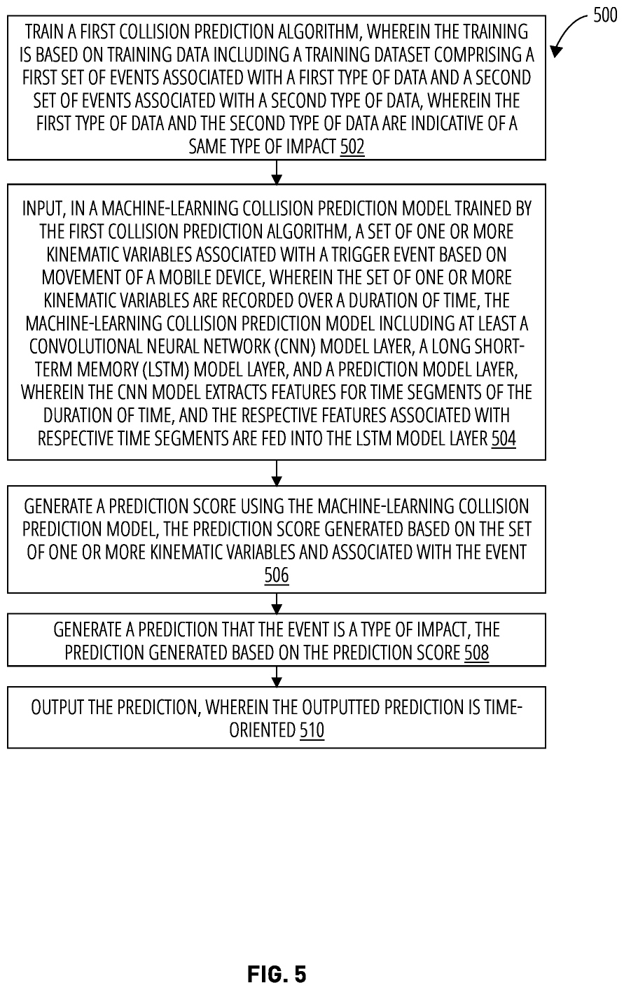

FIG. 5 illustrates example operations for training the prediction model for generating a prediction for a likelihood of a collision based on training data for generating a prediction for a likelihood of a collision based on a respective collision, which can be performed by any of the systems 100-300 and/or network environment 200. At operation 502, the method 500 includes training a first collision prediction algorithm, wherein the training is based on training data including a training dataset comprising a first set of events associated with a first type of data and a second set of events associated with a second type of data, wherein the first type of data and the second type of data are indicative of a same type of impact. In some examples, the collision prediction model may be trained using transfer learning.

At operation 504, the method 500 includes inputting, in a machine-learning collision prediction model trained by the first collision prediction algorithm, a set of one or more kinematic variables associated with a trigger event based on movement of a mobile device, wherein the set of one or more kinematic variables are recorded over a duration of time, the machine-learning collision prediction model including at least a convolutional neural network (CNN) model layer, a long short-term memory (LSTM) model layer, and a prediction model layer, wherein the CNN model extracts features for time segments of the duration of time, and the respective features associated with respective time segments are fed into the LSTM model layer. At operation 506, the method 500 includes generating a prediction score using the machine-learning collision prediction model, the prediction score generated based on the set of one or more kinematic variables and associated with the event. At operation 508, the method 500 includes generating a prediction that the event is a type of impact, the prediction generated based on the prediction score. At operation 510, the method 500 includes outputting the prediction, wherein the outputted prediction is time-oriented.

It is to be understood that the specific order or hierarchy of operations in the methods depicted in FIGS. 4-5 and throughout this disclosure are instances of example approaches and can be rearranged while remaining within the disclosed subject matter. For instance, any of the operations depicted in FIGS. 4-5 may be omitted, repeated, performed in parallel, performed in a different order, and/or combined with any other of the operations depicted in FIGS. 4-5 or discussed herein.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Furthermore, any term of degree such as, but not limited to, “substantially,” as used in the description and the appended claims, should be understood to include an exact, or a similar, but not exact configuration. Similarly, the terms “about” or “approximately,” as used in the description and the appended claims, should be understood to include the recited values or a value that is three times greater or one third of the recited values. For example, about 3 mm includes all values from 1 mm to 9 mm, and approximately 50 degrees includes all values from 16.6 degrees to 150 degrees.

Lastly, the terms “or” and “and/or,” as used herein, are to be interpreted as inclusive or meaning any one or any combination. Therefore, “A, B, or C” or “A, B, and/or C” mean any of the following: “A,” “B,” or “C”; “A and B”; “A and C”; “B and C”; “A, B and C.” An exception to this definition will occur only when a combination of elements, functions, steps or acts are in some way inherently mutually exclusive.

While the present disclosure has been described with reference to various implementations, it will be understood that these implementations are illustrative and that the scope of the present disclosure is not limited to them. Many variations, modifications, additions, and improvements are possible. More generally, implementations in accordance with the present disclosure have been described in the context of particular implementations. Functionality may be separated or combined differently in various implementations of the disclosure or described with different terminology. These and other variations, modifications, additions, and improvements may fall within the scope of the disclosure as defined in the claims that follow.

What is claimed is:

1. A method comprising:
inputting, in a machine-learning collision prediction model, a set of one or more kinematic variables associated with a trigger event based on movement of a mobile device, wherein the set of one or more kinematic variables are recorded over a duration of time, the machine-learning collision prediction model including at least a convolutional neural network (CNN) model layer, a long short-term memory (LSTM) model layer, and a prediction model layer, wherein the CNN model extracts features for time segments of the duration of time, and the respective features associated with respective time segments are fed into the LSTM model layer;
generating a prediction score using the machine-learning collision prediction model, the prediction score generated based on the set of one or more kinematic variables and associated with the event;
generating a prediction that the event is a type of impact, the prediction generated based on the prediction score; and
outputting the prediction, wherein the outputted prediction is time-oriented.

2. The method of claim 1, comprising:
generating the machine-learning collision prediction model by training a first collision prediction algorithm, wherein the training is based on training data including a training dataset comprising a first set of events associated with a first type of data and a second set of events associated with a second type of data, wherein the first type of data and the second type of data are indicative of a same type of impact.

3. The method of claim 1, comprising:
generating a high frequency CNN model and a low frequency CNN model in the CNN model layer, wherein the high frequency CNN model and the low frequency CNN model feed into respective LSTM models in the LSTM model layer;
concatenating outputs of the respective LSTM models together;
inputting the concatenated outputs into a dense layer to alter one or more dimensions of the concatenated outputs; and
inputting the altered outputs into a prediction layer to output the prediction.

4. The method of claim 3, wherein the prediction layer outputs the prediction using transfer learning.

5. The method of claim 3, wherein the high frequency CNN model receives accelerometer magnitude and interpolated global positioning system (GPS) speeds to a matching frequency that is convoluted together, and wherein the low frequency CNN model receives at least one of GPS speed, horizontal accuracy, or altitude.

6. The method of claim 1, wherein the set of one or more kinematic variables include at least one of global positioning system (GPS) speed variables, GPS altitude variables, or accelerometer magnitude variables.

7. The method of claim 1, wherein the prediction is generated based on a value of the prediction score being at or above a threshold value.

8. The method of claim 1, wherein the type of impact is a first type of impact or a second type of impact, and wherein the first type of impact and the second type of impact are associated with an event type.

9. The method of claim 8, wherein the event type associated with the first type of impact is a collision and the event type associated with the second type if impact is no collision.

10. The method of claim 8, further comprising:
determining, according to the set of one or more kinematic variables, that the event occurred within a geographic region indicated by one or more geospatial filters; and
generating the prediction that the event is the second type of impact based on the determination that the event occurred within the geographic region.

11. The method of claim 8, further comprising:
converting the set of one or more kinematic variables into features that represent GPS speed and altitude properties and accelerometer magnitude properties associated with the movement of the mobile device, wherein the prediction score is determined based on the features, and wherein the machine-learning collision prediction model is trained to learn which of the features contribute to predicting whether the movement is associated with the first type of impact.

12. A system comprising:
one or more processors;
a prediction system, wherein the prediction system includes a machine-learning collision prediction model comprising at least a first layer, a second layer, and a third layer; and
a memory storing computer-executable instructions that, when executed by the one or more processors, cause the system to:
input, into the machine-learning collision prediction model, a set of one or more kinematic variables associated with a trigger event based on movement of a mobile device, wherein the set of one or more kinematic variables are recorded over a duration of time, wherein the first model extracts features for time segments of the duration of time, and the respective features associated with respective time segments are fed into the second layer;
generate, by the machine-learning collision prediction model, a prediction score, wherein the prediction score is based on the set of one or more kinematic variables and associated with the event;
determine a prediction, according to the prediction score, that the event is a type of impact; and
output the prediction, wherein the outputted prediction is time-oriented.

13. The system of claim 12, wherein the machine-learning collision prediction model includes at least a convolutional neural network (CNN) model layer, a long short-term memory (LSTM) model layer, and a prediction model layer.

14. The system of claim 12, wherein the computer-executable instructions further configure the one or more processors to cause the system to:
generate the machine-learning collision prediction model by training a first collision prediction algorithm, wherein the training is based on training data including a training dataset comprising a first set of events associated with a first type of data and a second set of events associated with a second type of data, wherein the first type of data and the second type of data are indicative of a same type of impact.

15. The system of claim 13, wherein the computer-executable instructions further configure the one or more processors to cause the system to:
generate a high frequency CNN model and a low frequency CNN model in the first layer, wherein the high frequency CNN model and the low frequency CNN model feed into respective LSTM models in the second layer;
concatenate outputs of the respective LSTM models together;
input the concatenated outputs into a dense layer to alter one or more dimensions of the concatenated outputs; and
input the altered outputs into the prediction layer to output the prediction.

16. The system of claim 15, wherein the high frequency CNN model receives accelerometer magnitude and interpolated global positioning system (GPS) speeds to a matching frequency that is convoluted together, and wherein the low frequency CNN model receives at least one of GPS speed, horizontal accuracy, or altitude.

17. The system of claim 12, wherein the type of impact is a first type of impact or a second type of impact, and wherein the first type of impact and the second type of impact are associated with an event type.

18. The system of claim 17, wherein the event type associated with the first type of impact is a collision and the event type associated with the second type of impact is no collision.

19. The system of claim 17, wherein the computer-executable instructions further configure the one or more processors to cause the system to:
determine, according to the set of one or more kinematic variables, that the event occurred within a geographic region indicated by one or more geospatial filters; and
generate the prediction that the event is the second type of impact based on the determination that the event occurred within the geographic region.

20. One or more tangible non-transitory computer-readable storage media storing computer-executable instructions for performing a computer process on a computing system, the computer process comprising:
inputting, in a machine-learning collision prediction model, a set of one or more kinematic variables associated with a trigger event based on movement of a mobile device, wherein the set of one or more kinematic variables are recorded over a duration of time, wherein the machine-learning collision prediction model includes at least a high frequency convolutional neural network (CNN) model layer and a low frequency CNN layer, wherein the high frequency CNN layer and the low frequency CNN layer extract features for time segments of the duration of time, and the respective features associated with respective time segments are fed into one or more long short term memory (LSTM) model layers;
generating, by the machine-learning collision prediction model, a prediction score, wherein the prediction score is based on the set of one or more kinematic variables and associated with the event;
determining a prediction, according to the prediction score, that the event is one of a first type of impact; and
outputting the prediction, wherein the outputted prediction is time-oriented.
